(19) United States
(12) Patent Application Publication
(10) Pub. No.: US 2013/0046798 A1
(43) Pub. Date: Feb. 21, 2013

(54) METHOD AND APPARATUS FOR VISUALIZATION OF INFRASTRUCTURE USING A NON-RELATIONAL GRAPH DATA STORE

(71) Applicants: Serguei Mankovskii, Toronto (CA); Maria Velez-Rojas, Dublin, CA (US)

(72) Inventors: Serguei Mankovskii, Toronto (CA); Maria Velez-Rojas, Dublin, CA (US)

(73) Assignee: COMPUTER ASSOCIATES THINK, INC., Islandia, NY (US)

(21) Appl. No.: 13/210,847

(22) Filed: Aug. 16, 2011

(51) Int. Cl. G06F 17/30

(52) U.S. Cl. 707/805; 707/E17.03

(57) ABSTRACT

A system and method for visualization of an infrastructure is presented. The system comprises a non-relational graph data store caching data from one or more of a relational or non-relational data store, a graph visualization software operable to perform the visualization of the infrastructure using the cached data in the non-relational graph data store, and a graph database operable to implement analytic queries available to the graph visualization software through an exposed Application Program Interface. In one aspect, the graph database collects the cached data from the one or more relational or non-relational graph data stores. In one aspect, the cached data comprises nodes representing elements of the infrastructure, and links representing relationships among the nodes. In one aspect, the infrastructure is an IT infrastructure.

### CROSS REFERENCE TO RELATED APPLICATION

This application is related to commonly-owned, co-pending U.S. patent application Ser. No. 13/160,943 filed on Jun. 15, 2011, the entire contents and disclosure of which is expressly incorporated by reference as if fully set forth herein.

### FIELD

The present disclosure relates generally to visualization of a complex system, and more particularly to visualization of IT infrastructure using a non-relational graph data store.

### BACKGROUND

Information Technology (IT) supporting a modern large enterprise is a complex mix of networks, computers, applications, and services. The enterprise IT environment might contain tens of thousands of computers, thousands of networks connecting them, and hundreds of thousands of applications running on the computers. Enterprise IT management systems often represent the managed environment in the form of a graph where nodes represent elements of IT infrastructure and edges represent relationships among the elements. Graphs can be found in most of modern IT management products because users like the clarity and brevity enabled by this type of visualization. However the data used for creation of the visualization comes from relational databases keeping data in a multitude of different tables. It is common that that information about the nodes and their relationships comes from different tables, necessitating large numbers of queries over multiple tables to create a visualization of the IT infrastructure. These queries lead to inefficient use of the databases, resulting in high load on the database servers and storage devices.

In enterprise IT management, data about networks usually comes from multiple sources. FIG. 1 shows a “naïve” deployment architecture which includes a Graph Visualization Software 10 which receives network topology data from Network Management Database 12, computers and operating systems data from Systems Management Database 14 and application performance data from Applications Management Database 16. However, a plurality of databases supplying information for the visualization aggravates the problem of efficient graph visualization of the IT infrastructure, and introduces an additional problem of information integration.

In an attempt to address issues associated with information integration and real-life application use, an intermediate relational database playing the role of a Relational Data Warehouse 18 is often used. However this architecture, shown in FIG. 2, does not address graph visualization efficiency. The Relational Data Warehouse 18 is inefficient for the visualization of graph structures because it uses relational tables for integrating and storing the data. Moreover, because of the relational format in which data is stored, it takes time to gather or collect data. In addition, as the amount of data increases, the time to gather the data grows exponentially.

### BRIEF SUMMARY

An inventive mechanism for visualization of infrastructure that solves these problems is presented. The novel mechanism uses a non-relational graph data store to cache data as it is prepared for visualization. The infrastructure can be an IT infrastructure.

A method for visualization of an infrastructure using a non-relational graph data store is presented. The novel method comprises caching data from one or more relational and/or non-relational data store, performing, using graph visualization software on a processor, the visualization of the IT infrastructure using the cached data in the non-relational graph data store, and implementing analytic queries available to the graph visualization software though an exposed Application Programmer Interface.

In one aspect, the cached data from the one or more relational and/or non-relational data stores is collected in a relational data warehouse. In one aspect, the cached data comprises nodes representing elements of the IT infrastructure, and links representing relationships among the nodes. In one aspect, the infrastructure is an IT infrastructure.

A system for visualization of an infrastructure is presented. The novel system comprises a non-relational graph data store caching data from one or more of a relational or non-relational data store, a graph visualization software operable to perform the visualization of the infrastructure using the data in the non-relational graph data store, and a graph database operable to implement analytic queries available to the graph visualization software through an exposed Application Programmer Interface.

In one aspect, the graph database collects data from the one or more relational or non-relational graph data stores. In one aspect, the cached data comprises nodes representing elements of the IT infrastructure, and links representing relationships among the nodes. In one aspect, the infrastructure is an IT infrastructure.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an example of a prior art architecture for enterprise IT graph visualization.

FIG. 2 an example of another prior art architecture for enterprise IT graph visualization.

FIG. 3 is a schematic of an embodiment of the inventive system.

FIG. 4 is a schematic of another embodiment of the inventive system.

FIG. 5 is a flow diagram of the inventive method in one embodiment.

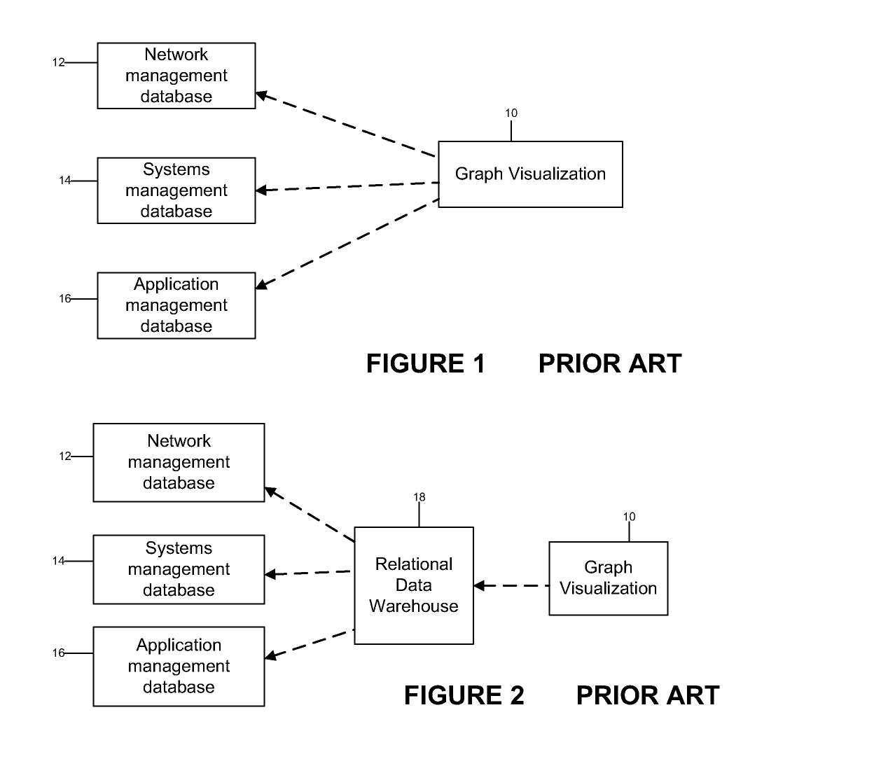

### DETAILED DESCRIPTION

An inventive system and method for visualization of an infrastructure, such as an IT infrastructure, using a non-relational graph data store is presented. The approach enables visualization of an IT environment by effective visualization of enterprise IT management data. The novel technique uses an intermediate cache that stores data as a graph, e.g., a collection of nodes, each representing an element, and links, each representing a relationship among elements, instead of a relational table. Data representation based on graph theory can be stored in a graph database management system, such as the DEX data store by Sparsity Technologies or Google Perculator Page Rank by Google®.

The invention provides a cache, that is, a back-end or staging area, to facilitate visualization. Data describing and/or documenting the IT infrastructure is obtained from various sources, such as a network management database, a systems management database, an applications management database, in conventional form and integrated into a non-relational graph data store or graph database. By using this non-relational format, both the data collection and visualization of the IT structure are performed much more quickly than if the data were retrieved from a relational database.

A graph database, often used in conjunction with social networking, represents and stores information using a graph structure with nodes, edges and properties. Hence, with the graph database, connectivity between and among elements can be retrieved in addition to the elements themselves. This is unlike a relational database which maintains relations among elements but only allows retrieval of data elements not of the relations themselves. In the inventive system, the graph database is used for caching data collected in data stores in plurality of social networking systems. The cache has a number of embedded analytic functions exposed through an Application Programmer Interface (“API”). The API provides access to analytic functions such as, but not limited to: retrieving all related graph nodes, scanning in forward and reverse direction of graph arch, degree of node, shortest path between nodes, degree of interest of node similar to Page Rank, etc.

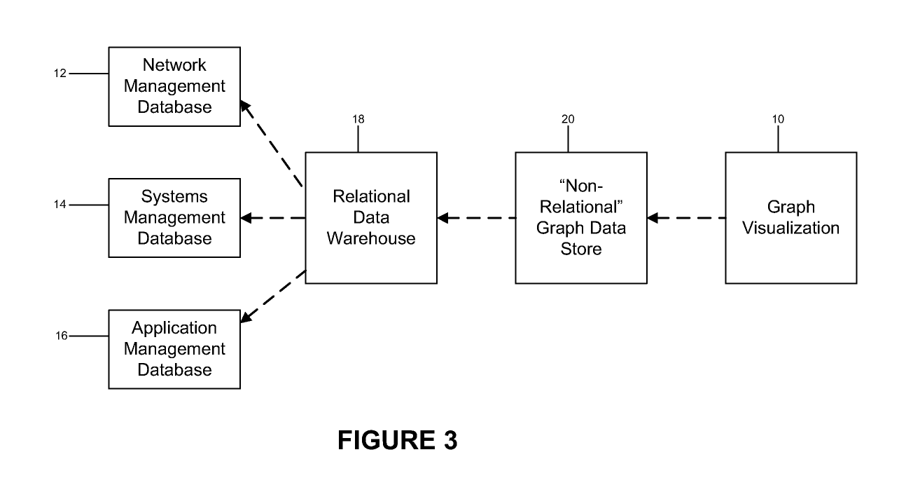

FIG. 3 is a schematic of an embodiment of a system for enterprise IT graph visualization in accordance with the present invention. FIG. 3 shows a system having a network management database 12, a systems management database 14, and an applications management database 16, all of which supply information to the relational database warehouse 18. A “non-relational” graph data store 20, which can be deployed as a graph visualization accelerator, obtains information from the relational database warehouse 18 and provides this information to the visualization software 10 which performs the visualization of the IT infrastructure.

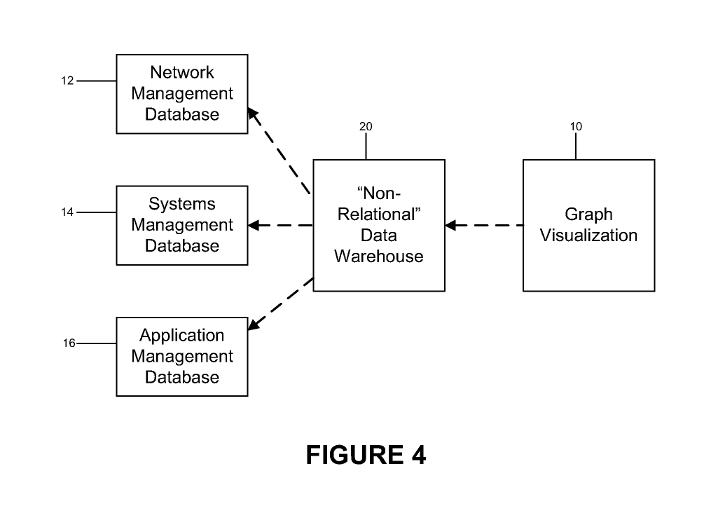

FIG. 4 is a schematic of another embodiment of a system for enterprise IT graph visualization in accordance with the present invention. In the system shown in FIG. 4, the “non-relational” graph data store collects data directly from the various system data repositories, such as a network management database 12, a systems management database 14, and an applications management database 16. As with the embodiment shown in FIG. 3, the non-relational graph data store can be deployed as graph visualization accelerator and provides information to the graph visualization software 10.

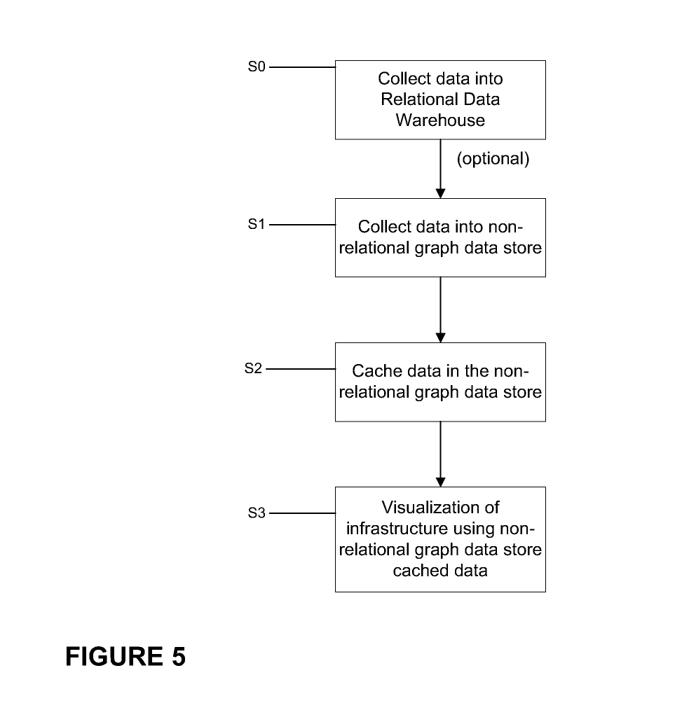

FIG. 5 is a flow diagram of the inventive method. In step S1, data is collected from the IT infrastructure, including from a network management database, a systems management database and an applications management database. In one embodiment, the data is collected and gathered in a relational data warehouse in step S0. In step S2, the collected data is cached in the non-relational graph data store. In step S3, the cached data is used for visualization of the IT infrastructure. Advantageously, the invention dramatically reduces time required for visualization of the IT infrastructure.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A system for visualization of an infrastructure comprising:
a non-relational graph data store that is configured to cache data from a plurality of relational or non-relational databases, wherein the cached data comprises both network topology data that describes a topology of a communication network embodied in the infrastructure and application data that describes applications deployed in the infrastructure, and wherein the cached data is organized in the form of nodes representing elements of the infrastructure and links representing relationships among the nodes; and
a graph visualization processor that is configured to perform visualization of the infrastructure using the cached data in the non-relational graph data store, including visualization of nodes representing network elements in the infrastructure and nodes representing applications in the infrastructure;
wherein the non-relational graph data store is configured to execute analytic queries accessible to the graph visualization processor through an exposed Application Programmer Interface.

2. The system according to claim 1, wherein the non-relational graph data store is further configured to collect the cached data from the plurality of relational or non-relational graph databases.

3. (canceled)

4. The system according to claim 1, wherein the infrastructure is an information technology infrastructure.

5. A method for visualization of an infrastructure, the method comprising:
caching data from a plurality of a relational or non-relational databases in a non-relational graph data store, wherein the cached data includes both network topology data that describes a topology of a communication network embodied in the infrastructure and application data that describes applications deployed in the infrastructure, and wherein the cached data is organized in the form of nodes representing elements of the infrastructure and links representing relationships among the nodes;
performing, using graph visualization software on a processor, visualization of the infrastructure, including visualization of nodes representing network elements in the infrastructure and nodes representing applications in the infrastructure, using the cached data in the non-relational graph data store; and
executing analytic queries on the cached data in the non-relational graph data store accessible to the graph visualization software though an exposed Application Programmer Interface.

6. The method according to claim 5, further comprising collecting the cached data in the plurality of relational or non-relational databases.

7. (canceled)

8. The method according to claim 5, wherein the infrastructure is an information technology infrastructure.

9. A computer readable storage medium storing a program of instructions executable by a computer to perform a method for visualization of an infrastructure comprising:
computer readable configured to cache data from a plurality of relational or non-relational databases in a non-relational graph data store, wherein the cached data includes both network topology data that describes a topology of a communication network embodied in the infrastructure and application data that describes applications deployed in the infrastructure, and wherein the cached data is organized in the form of nodes representing elements of the infrastructure and links representing relationships among the nodes;
computer readable configured to perform, using graph visualization software on a processor, including visualization of nodes representing network elements in the infrastructure and nodes representing applications in the infrastructure, the visualization of the IT infrastructure using the cached data in the non-relational graph data store; and
computer readable configured to execute analytic queries accessible to the graph visualization software though an exposed Application Programmer Interface.

10. The computer readable storage medium according to claim 9, further comprising computer readable configured to collect the cached data in the plurality of relational or non-relational databases.

11. (canceled)

12. The computer readable storage medium according to claim 9, wherein the infrastructure is an information technology infrastructure.

13. The system according to claim 1, wherein the cached data further comprises computers and operating system data describing computers and operating systems included in the infrastructure.

14. The system according to claim 1, wherein the non-relational graph data store is configured to extract the non-relational graph data from a relational data warehouse that stores relational data received from the plurality of relational or non-relational databases.

15. The method according to claim 5, wherein the cached data further comprises computers and operating system data describing computers and operating systems included in the infrastructure.

16. The method according to claim 5, wherein the non-relational graph data store is configured to extract the non-relational graph data from a relational data warehouse that stores relational data received from the plurality of relational or non-relational databases.

17. The computer readable storage medium according to claim 9, wherein the cached data further comprises computers and operating system data describing computers and operating systems included in the infrastructure.

18. The computer readable storage medium according to claim 9, further comprising computer readable configured to extract the non-relational graph data from a relational data warehouse that stores relational data received from the plurality of relational or non-relational databases.
